(19) United States
(12) Patent Application Publication
(10) Pub. No.: US 2021/0192641 A1
(43) Pub. Date: Jun. 24, 2021

(54) System, Method, and Computer Program Product for Determining Correspondence of Non-Indexed Records

(71) Applicant: Visa International Service Association, San Francisco, CA (US)

(72) Inventors: Rajat Das, San Mateo, CA (US); Michael Kenji Mori, San Mateo, CA (US)

(21) Appl. No.: 17/128,572

(22) Filed: Dec. 21, 2020

Related U.S. Application Data
(60) Provisional application No. 62/952,950, filed on Dec. 23, 2019.

(51) Int. Cl. G06Q 40/00; G06F 16/23; G06Q 10/10; G06Q 40/02; G06N 20/00; G06N 5/04

(52) U.S. Cl. CPC G06Q 40/12; G06F 16/2379; G06F 16/2365; G06Q 30/0185; G06Q 40/02; G06N 20/00; G06N 5/04; G06Q 10/10

(57) ABSTRACT

Systems, computer-implemented methods, and computer program products for determining correspondence of non-indexed records are described herein. The method may include receiving a clearing record including at least one key field, comparing a value associated with a first key field of the clearing record to a value associated with a first key field of one or more authorization records associated with one or more payment transactions, and determining that the clearing record corresponds to an authorization record from among the one or more authorization records based on comparing the value associated with the first key field of the clearing record to the value associated with the first key field of the one or more authorization records. The method also includes generating an updated clearing record based on determining that the clearing record corresponds to the authorization record, and transmitting the updated clearing record.

### CROSS-REFERENCE TO RELATED APPLICATION

This application claims priority to U.S. Provisional Patent Application No. 62/952,950 filed on Dec. 23, 2019, the disclosure of which is incorporated by reference herein in its entirety.

### BACKGROUND

### 1. Field

This disclosure relates generally to determining correspondence of non-indexed records and, in some non-limiting embodiments or aspects, to systems, methods, and computer program products for predicting that a clearing record corresponds to an authorization record when the clearing record is not identified as corresponding to the authorization record in an index.

### 2. Technical Considerations

After initiation and approval of a payment transaction by an individual, an authorization record may be generated and maintained by an issuer institution involved in the payment transaction, and a hold placed on an account of the individual. An acquirer institution may transmit a clearing record associated with the payment transaction to finalize the payment transaction. However, upon receipt, the issuer institution may be unable to accurately determine which authorization record corresponds to the clearing record. For example, where an approved transaction amount specified in an authorization record does not match a final transaction amount specified by a clearing record (e.g., where a tip was added to the approved transaction amount after approval, where a change in currency affected the final transaction amount, where an authorization record for the payment transaction is removed from a database after a period of time (e.g., five days) to conserve space in the database, and/or the like), the issuer institution may not be able to accurately determine that an authorization record matches the clearing record. The issuer institution may then process the clearing record as a force-post payment transaction (e.g., a payment transaction approved by a merchant system without obtaining authorization from an issuer system involved in the payment transaction such as, for example, by providing a previously-obtained authorization code).

Force-post payment transactions may be susceptible to chargebacks if the force-post payment transaction is for a fraudulent payment transaction (e.g., a payment transaction during which a payment device is used to initiate a payment transaction by an individual that is not permitted to use the payment device) and/or if the force-post payment transaction is for a payment transaction that was not previously authorized (e.g., a payment transaction that was not pre-authorized by an issuer system). If an issuer institution cannot identify a match for a clearing record, the issuer institution may be required to process the clearing record as a force-post payment transaction, and may subsequently issue a chargeback if the force-post payment transaction is fraudulent and/or unauthorized, consuming additional network resources.

There is a need in the art for improved systems and methods for identifying matches between clearing records and authorization records, including in cases where a clearing record does not exactly correspond with an authorization record. There is a further need in the art for improved systems and methods for accurately identifying clearing records as being associated with force-post payment transactions.

### SUMMARY

Accordingly, disclosed are systems, methods, and computer program products for determining correspondence of non-indexed records by determining whether a clearing record corresponds to an authorization record.

According to some non-limiting embodiments or aspects, provided is a computer-implemented method for determining correspondence of non-indexed records. The method may include receiving, with at least one processor, a clearing record including at least one key field, the clearing record associated with one or more payment transactions that were completed in a payment transaction processing network. The method also may include comparing, with at least one processor, a value associated with a first key field of the clearing record to a value associated with a first key field of one or more authorization records associated with one or more payment transactions that were authorized in the payment transaction processing network, the first key field of the clearing record corresponding to the first key field of the one or more authorization records. The one or more authorization records may be associated with an authorization request for a payment transaction of the one or more payment transactions. The method may further include determining, with at least one processor, that the clearing record corresponds to an authorization record from among the one or more authorization records based on comparing the value associated with the first key field of the clearing record to the value associated with the first key field of the one or more authorization records. The method may further include generating, with at least one processor, an updated clearing record based on determining that the clearing record corresponds to the authorization record. The method may further include transmitting, with at least one processor, the updated clearing record.

In some non-limiting embodiments or aspects, receiving the clearing record associated with the one or more payment transactions may include receiving, with at least one processor, a clearing batch file including a plurality of clearing records for a plurality of payment transactions. The method may further include normalizing, with at least one processor, one or more clearing records of the plurality of clearing records of the clearing batch file based on a clearing record template associated with an issuer system. When normalizing the one or more clearing records of the clearing batch file, the at least one processor may convert one or more values associated with one or more key fields of the one or more clearing records to one or more updated values.

In some non-limiting embodiments or aspects, the method may include comparing, with at least one processor, a value associated with a second key field of the clearing record to a value associated with a second key field of the one or more authorization records. The second key field of the clearing record may correspond to the second key field of the one or more authorization records. Determining that the clearing record corresponds to the authorization record from among the one or more authorization records may include determining, with at least one processor, that the clearing record corresponds to the authorization record from among the one or more authorization records based on comparing the value associated with the second key field of the clearing record to the value associated with the second key field of the one or more authorization records. The first key field may be associated with at least one of a transaction identifier, a transaction amount, and a payment account type, and the second key field may be associated with another of the at least one of the transaction identifier, the transaction amount, and the payment account type.

In some non-limiting embodiments or aspects, determining that the clearing record corresponds to the authorization record from among the one or more authorization records may include determining, with at least one processor, that the value associated with the first key field of the clearing record matches the value associated with the first key field of the authorization record. Determining that the clearing record corresponds to the authorization record from among the one or more authorization records may also include determining, with at least one processor, that the value associated with the second key field of the clearing record does not match the value associated with the second key field of the authorization record. The method may further include determining, with at least one processor, that the clearing record partially matches the authorization record based on determining that the value associated with the first key field of the clearing record matches the value associated with the first key field of the authorization record and that the value associated with the second key field of the clearing record does not match the value associated with the second key field of the authorization record.

In some non-limiting embodiments or aspects, determining that the clearing record corresponds to the authorization record from among the one or more authorization records may include determining, with at least one processor, that the value associated with the first key field of the clearing record matches the value associated with the first key field of the authorization record. Determining that the clearing record corresponds to the authorization record from among the one or more authorization records may also include determining, with at least one processor, that the value associated with the second key field of the clearing record matches the value associated with the second key field of the authorization record. The method may further include determining, with at least one processor, that the clearing record matches the authorization record based on determining that the value associated with the first key field of the clearing record matches the value associated with the first key field of the authorization record, and that the value associated with the second key field of the clearing record matches the value associated with the second key field of the authorization record.

In some non-limiting embodiments or aspects, determining that the clearing record corresponds to the authorization record from among the one or more authorization records may include determining, with at least one processor, that the value associated with the first key field of the clearing record does not match the value associated with the first key field of the authorization record. Determining that the clearing record corresponds to the authorization record from among the one or more authorization records may also include determining, with at least one processor, that the value associated with the second key field of the clearing record does not match the value associated with the second key field of the authorization record. The method may further include determining, with at least one processor, that the clearing record does not match the authorization record based on determining that the value associated with the first key field of the clearing record does not match the value associated with the first key field of the authorization record, and that the value associated with the second key field of the clearing record does not match the value associated with the second key field of the authorization record.

In some non-limiting embodiments or aspects, generating the updated clearing record may include providing, with at least one processor, the clearing record and the authorization record as input to a machine learning model, and generating, with at least one processor, a prediction associated with a confidence score that the clearing record matches the authorization record based on providing the clearing record and the authorization record as the input to the machine learning model. Generating the updated clearing record may also include updating, with at least one processor, the clearing record based on the confidence score.

In some non-limiting embodiments or aspects, updating the clearing record based on the confidence score may include at least one of: (i) appending, with at least one processor, the confidence score to the clearing record; (ii) appending, with at least one processor, an original transaction amount of the authorization record to the clearing record; and (iii) appending, with at least one processor, a transaction identifier of the authorization record to the clearing record.

In some non-limiting embodiments or aspects, the method may include generating, with at least one processor, an updated clearing batch file based on the clearing batch file and the updated clearing record. Transmitting the updated clearing record may include transmitting, with at least one processor, the updated clearing batch file to an issuer system.

In some non-limiting embodiments or aspects, generating the updated clearing record based on determining that the clearing record corresponds to the authorization record may include providing, with at least one processor, the clearing record and the one or more authorization records to a machine learning model, and generating, with at least one processor, a prediction associated with a merchant transaction pattern and a confidence score based on providing the clearing record and the one or more authorization records to the machine learning model. Generating the updated clearing record based on determining that the clearing record corresponds to the authorization record may also include updating, with at least one processor, the clearing record based on the merchant transaction pattern and the confidence score.

According to some non-limiting embodiments or aspects, provided is a system for determining correspondence of non-indexed records. The system may include a server including at least one processor. The at least one processor may be programmed and/or configured to receive a clearing record including at least one key field, the clearing record associated with one or more payment transactions that were completed in a payment transaction processing network. The at least one processor may be programmed and/or configured to compare a value associated with a first key field of the clearing record to a value associated with a first key field of one or more authorization records associated with one or more payment transactions that were authorized in the payment transaction processing network, the first key field of the clearing record corresponding to the first key field of the one or more authorization records. The one or more authorization records may be associated with an authorization request for a payment transaction of the one or more payment transactions. The at least one processor may be programmed and/or configured to determine that the clearing record corresponds to an authorization record from among the one or more authorization records based on comparing the value associated with the first key field of the clearing record to the value associated with the first key field of the one or more authorization records. The at least one processor may be programmed and/or configured to generate an updated clearing record based on determining that the clearing record corresponds to the authorization record. The at least one processor may be programmed and/or configured to transmit the updated clearing record.

In some non-limiting embodiments or aspects, receiving the clearing record associated with the one or more payment transactions may include receiving a clearing batch file including a plurality of clearing records for a plurality of payment transactions. The at least one processor may be further programmed and/or configured to normalize one or more clearing records of the plurality of clearing records of the clearing batch file based on a clearing record template associated with an issuer system. When normalizing the one or more clearing records of the clearing batch file, the at least one processor may convert one or more values associated with one or more key fields of the one or more clearing records to one or more updated values.

In some non-limiting embodiments or aspects, the at least one processor may be further programmed and/or configured to compare a value associated with a second key field of the clearing record to a value associated with a second key field of the one or more authorization records. The second key field of the clearing record may correspond to the second key field of the one or more authorization records. Determining that the clearing record corresponds to the authorization record from among the one or more authorization records may include determining that the clearing record corresponds to the authorization record from among the one or more authorization records based on comparing the value associated with the second key field of the clearing record to the value associated with the second key field of the one or more authorization records. The first key field may be associated with at least one of a transaction identifier, a transaction amount, and a payment account type, and the second key field may be associated with another of the at least one of the transaction identifier, the transaction amount, and the payment account type.

In some non-limiting embodiments or aspects, determining that the clearing record corresponds to the authorization record from among the one or more authorization records may include determining that the value associated with the first key field of the clearing record matches the value associated with the first key field of the authorization record, and determining that the value associated with the second key field of the clearing record does not match the value associated with the second key field of the authorization record. The at least one processor may be further programmed and/or configured to determine that the clearing record partially matches the authorization record based on determining that the value associated with the first key field of the clearing record matches the value associated with the first key field of the authorization record, and that the value associated with the second key field of the clearing record does not match the value associated with the second key field of the authorization record.

In some non-limiting embodiments or aspects, generating the updated clearing record may include providing the clearing record and the authorization record as input to a machine learning model, and generating a prediction associated with a confidence score that the clearing record matches the authorization record based on providing the clearing record and the authorization record as the input to the machine learning model. Generating the updated clearing record may also include updating the clearing record based on the confidence score.

According to some non-limiting embodiments or aspects, provided is a computer program product for determining correspondence of non-indexed records. The computer program product may include a non-transitory computer-readable medium storing program instructions configured to cause at least one processor to receive a clearing record including at least one key field, the clearing record associated with one or more payment transactions that were completed in a payment transaction processing network. The program instructions may be configured to cause the at least one processor to compare a value associated with a first key field of the clearing record to a value associated with a first key field of one or more authorization records associated with one or more payment transactions that were authorized in the payment transaction processing network, the first key field of the clearing record corresponding to the first key field of the one or more authorization records. The one or more authorization records may be associated with an authorization request for a payment transaction of the one or more payment transactions. The program instructions may be configured to cause the at least one processor to determine that the clearing record corresponds to an authorization record from among the one or more authorization records based on comparing the value associated with the first key field of the clearing record to the value associated with the first key field of the one or more authorization records. The program instructions may be configured to cause the at least one processor to generate an updated clearing record based on determining that the clearing record corresponds to the authorization record. The program instructions may be configured to cause the at least one processor to transmit the updated clearing record.

In some non-limiting embodiments or aspects, receiving the clearing record associated with the one or more payment transactions may include receiving a clearing batch file including a plurality of clearing records for a plurality of payment transactions. The program instructions may be further configured to cause the at least one processor to normalize one or more clearing records of the plurality of clearing records of the clearing batch file based on a clearing record template associated with an issuer system. When normalizing the one or more clearing records of the clearing batch file, the at least one processor may convert one or more values associated with one or more key fields of the one or more clearing records to one or more updated values.

In some non-limiting embodiments or aspects, the program instructions may further cause the at least one processor to compare a value associated with a second key field of the clearing record to a value associated with a second key field of the one or more authorization records, the second key field of the clearing record corresponding to the second key field of the one or more authorization records. Determining that the clearing record corresponds to the authorization record from among the one or more authorization records may include determining that the clearing record corresponds to the authorization record from among the one or more authorization records based on comparing the value associated with the second key field of the clearing record to the value associated with the second key field of the one or more authorization records. The first key field may be associated with at least one of a transaction identifier, a transaction amount, and a payment account type, and the second key field may be associated with another of the at least one of the transaction identifier, the transaction amount, and the payment account type.

In some non-limiting embodiments or aspects, determining that the clearing record corresponds to the authorization record from among the one or more authorization records may include determining that the value associated with the first key field of the clearing record matches the value associated with the first key field of the authorization record, and determining that the value associated with the second key field of the clearing record does not match the value associated with the second key field of the authorization record. The program instructions may be further configured to cause the at least one processor to determine that the clearing record partially matches the authorization record based on determining that the value associated with the first key field of the clearing record matches the value associated with the first key field of the authorization record, and that the value associated with the second key field of the clearing record does not match the value associated with the second key field of the authorization record.

In some non-limiting embodiments or aspects, generating the updated clearing record may include providing the clearing record and the authorization record as input to a machine learning model, and generating a prediction associated with a confidence score that the clearing record matches the authorization record based on providing the clearing record and the authorization record as the input to the machine learning model. Generating the updated clearing record may further include updating the clearing record based on the confidence score.

Other non-limiting embodiments or aspects of the present disclosure will be set forth in the following numbered clauses:

Clause 1: A computer-implemented method, comprising: receiving, with at least one processor, a clearing record comprising at least one key field, the clearing record associated with one or more payment transactions that were completed in a payment transaction processing network; comparing, with at least one processor, a value associated with a first key field of the clearing record to a value associated with a first key field of one or more authorization records associated with one or more payment transactions that were authorized in the payment transaction processing network, the first key field of the clearing record corresponding to the first key field of the one or more authorization records, wherein the one or more authorization records are associated with an authorization request for a payment transaction of the one or more payment transactions; determining, with at least one processor, that the clearing record corresponds to an authorization record from among the one or more authorization records based on comparing the value associated with the first key field of the clearing record to the value associated with the first key field of the one or more authorization records; generating, with at least one processor, an updated clearing record based on determining that the clearing record corresponds to the authorization record; and transmitting, with at least one processor, the updated clearing record.

Clause 2: The computer-implemented method of clause 1, wherein receiving the clearing record associated with the one or more payment transactions comprises: receiving, with at least one processor, a clearing batch file comprising a plurality of clearing records for a plurality of payment transactions, the computer-implemented method further comprising: normalizing, with at least one processor, one or more clearing records of the plurality of clearing records of the clearing batch file based on a clearing record template associated with an issuer system, wherein, when normalizing the one or more clearing records of the clearing batch file, the at least one processor converts one or more values associated with one or more key fields of the one or more clearing records to one or more updated values.

Clause 3: The computer-implemented method of clause 1 or 2, further comprising: comparing, with at least one processor, a value associated with a second key field of the clearing record to a value associated with a second key field of the one or more authorization records, the second key field of the clearing record corresponding to the second key field of the one or more authorization records, wherein determining that the clearing record corresponds to the authorization record from among the one or more authorization records comprises: determining, with at least one processor, that the clearing record corresponds to the authorization record from among the one or more authorization records based on comparing the value associated with the second key field of the clearing record to the value associated with the second key field of the one or more authorization records; wherein the first key field is associated with at least one of a transaction identifier, a transaction amount, and a payment account type, and wherein the second key field is associated with another of the at least one of the transaction identifier, the transaction amount, and the payment account type.

Clause 4: The computer-implemented method of any of clauses 1-3, wherein determining that the clearing record corresponds to the authorization record from among the one or more authorization records comprises: determining, with at least one processor, that the value associated with the first key field of the clearing record matches the value associated with the first key field of the authorization record; and determining, with at least one processor, that the value associated with the second key field of the clearing record does not match the value associated with the second key field of the authorization record, the computer-implemented method further comprising: determining, with at least one processor, that the clearing record partially matches the authorization record based on determining that the value associated with the first key field of the clearing record matches the value associated with the first key field of the authorization record and that the value associated with the second key field of the clearing record does not match the value associated with the second key field of the authorization record.

Clause 5: The computer-implemented method of any of clauses 1-4, wherein determining that the clearing record corresponds to the authorization record from among the one or more authorization records comprises: determining, with at least one processor, that the value associated with the first key field of the clearing record matches the value associated with the first key field of the authorization record; and determining, with at least one processor, that the value associated with the second key field of the clearing record matches the value associated with the second key field of the authorization record, the computer-implemented method further comprising: determining, with at least one processor, that the clearing record matches the authorization record based on determining that the value associated with the first key field of the clearing record matches the value associated with the first key field of the authorization record and that the value associated with the second key field of the clearing record matches the value associated with the second key field of the authorization record.

Clause 6: The computer-implemented method of any of clauses 1-5, wherein determining that the clearing record corresponds to the authorization record from among the one or more authorization records comprises: determining, with at least one processor, that the value associated with the first key field of the clearing record does not match the value associated with the first key field of the authorization record; and determining, with at least one processor, that the value associated with the second key field of the clearing record does not match the value associated with the second key field of the authorization record, the computer-implemented method further comprising: determining, with at least one processor, that the clearing record does not match the authorization record based on determining that the value associated with the first key field of the clearing record does not match the value associated with the first key field of the authorization record and that the value associated with the second key field of the clearing record does not match the value associated with the second key field of the authorization record.

Clause 7: The computer-implemented method of any of clauses 1-6, wherein generating the updated clearing record comprises: providing, with at least one processor, the clearing record and the authorization record as input to a machine learning model; generating, with at least one processor, a prediction associated with a confidence score that the clearing record matches the authorization record based on providing the clearing record and the authorization record as the input to the machine learning model; and updating, with at least one processor, the clearing record based on the confidence score.

Clause 8: The computer-implemented method of any of clauses 1-7, wherein updating the clearing record based on the confidence score comprises at least one of: appending, with at least one processor, the confidence score to the clearing record; appending, with at least one processor, an original transaction amount of the authorization record to the clearing record; and appending, with at least one processor, a transaction identifier of the authorization record to the clearing record.

Clause 9: The computer-implemented method of any of clauses 1-8, further comprising: generating, with at least one processor, an updated clearing batch file based on the clearing batch file and the updated clearing record; wherein transmitting the updated clearing record comprises: transmitting, with at least one processor, the updated clearing batch file to an issuer system.

Clause 10: The computer implemented method of any of clauses 1-9, wherein generating the updated clearing record based on determining that the clearing record corresponds to the authorization record comprises: providing, with at least one processor, the clearing record and the one or more authorization records to a machine learning model; generating, with at least one processor, a prediction associated with a merchant transaction pattern and a confidence score based on providing the clearing record and the one or more authorization records to the machine learning model; and updating, with at least one processor, the clearing record based on the merchant transaction pattern and the confidence score.

Clause 11: A system comprising a server including at least one processor, the at least one processor programmed and/or configured to: receive a clearing record comprising at least one key field, the clearing record associated with one or more payment transactions that were completed in a payment transaction processing network; compare a value associated with a first key field of the clearing record to a value associated with a first key field of one or more authorization records associated with one or more payment transactions that were authorized in the payment transaction processing network, the first key field of the clearing record corresponding to the first key field of the one or more authorization records, wherein the one or more authorization records are associated with an authorization request for a payment transaction of the one or more payment transactions; determine that the clearing record corresponds to an authorization record from among the one or more authorization records based on comparing the value associated with the first key field of the clearing record to the value associated with the first key field of the one or more authorization records; generate an updated clearing record based on determining that the clearing record corresponds to the authorization record; and transmit the updated clearing record.

Clause 12: The system of clause 11, wherein receiving the clearing record associated with the one or more payment transactions comprises: receiving a clearing batch file comprising a plurality of clearing records for a plurality of payment transactions, the at least one processor being further programmed and/or configured to: normalize one or more clearing records of the plurality of clearing records of the clearing batch file based on a clearing record template associated with an issuer system, wherein, when normalizing the one or more clearing records of the clearing batch file, the at least one processor converts one or more values associated with one or more key fields of the one or more clearing records to one or more updated values.

Clause 13: The system of clause 11 or 12, wherein the at least one processor is further programmed and/or configured to: compare a value associated with a second key field of the clearing record to a value associated with a second key field of the one or more authorization records, the second key field of the clearing record corresponding to the second key field of the one or more authorization records, wherein determining that the clearing record corresponds to the authorization record from among the one or more authorization records comprises: determining that the clearing record corresponds to the authorization record from among the one or more authorization records based on comparing the value associated with the second key field of the clearing record to the value associated with the second key field of the one or more authorization records; wherein the first key field is associated with at least one of a transaction identifier, a transaction amount, and a payment account type, and wherein the second key field is associated with another of the at least one of the transaction identifier, the transaction amount, and the payment account type.

Clause 14: The system of any of clauses 11-13, wherein determining that the clearing record corresponds to the authorization record from among the one or more authorization records comprises: determining that the value associated with the first key field of the clearing record matches the value associated with the first key field of the authorization record; and determining that the value associated with the second key field of the clearing record does not match the value associated with the second key field of the authorization record, the at least one processor being further programmed and/or configured to: determine that the clearing record partially matches the authorization record based on determining that the value associated with the first key field of the clearing record matches the value associated with the first key field of the authorization record and that the value associated with the second key field of the clearing record does not match the value associated with the second key field of the authorization record.

Clause 15: The system of any of clauses 11-14, wherein generating the updated clearing record comprises: providing the clearing record and the authorization record as input to a machine learning model; generating a prediction associated with a confidence score that the clearing record matches the authorization record based on providing the clearing record and the authorization record as the input to the machine learning model; and updating the clearing record based on the confidence score.

Clause 16: A computer program product comprising a non-transitory computer-readable medium storing program instructions configured to cause at least one processor to: receive a clearing record comprising at least one key field, the clearing record associated with one or more payment transactions that were completed in a payment transaction processing network; compare a value associated with a first key field of the clearing record to a value associated with a first key field of one or more authorization records associated with one or more payment transactions that were authorized in the payment transaction processing network, the first key field of the clearing record corresponding to the first key field of the one or more authorization records, wherein the one or more authorization records are associated with an authorization request for a payment transaction of the one or more payment transactions; determine that the clearing record corresponds to an authorization record from among the one or more authorization records based on comparing the value associated with the first key field of the clearing record to the value associated with the first key field of the one or more authorization records; generate an updated clearing record based on determining that the clearing record corresponds to the authorization record; and transmit the updated clearing record.

Clause 17: The computer program product of clause 16, wherein receiving the clearing record associated with the one or more payment transactions comprises: receiving a clearing batch file comprising a plurality of clearing records for a plurality of payment transactions, the program instructions being further configured to cause the at least one processor to: normalize one or more clearing records of the plurality of clearing records of the clearing batch file based on a clearing record template associated with an issuer system, wherein, when normalizing the one or more clearing records of the clearing batch file, the at least one processor converts one or more values associated with one or more key fields of the one or more clearing records to one or more updated values.

Clause 18: The computer program product of clause 16 or 17, wherein the program instructions are further configured to cause the at least one processor to: compare a value associated with a second key field of the clearing record to a value associated with a second key field of the one or more authorization records, the second key field of the clearing record corresponding to the second key field of the one or more authorization records, wherein determining that the clearing record corresponds to the authorization record from among the one or more authorization records comprises: determining that the clearing record corresponds to the authorization record from among the one or more authorization records based on comparing the value associated with the second key field of the clearing record to the value associated with the second key field of the one or more authorization records; wherein the first key field is associated with at least one of a transaction identifier, a transaction amount, and a payment account type, and wherein the second key field is associated with another of the at least one of the transaction identifier, the transaction amount, and the payment account type.

Clause 19: The computer program product of any of clauses 16-18, wherein determining that the clearing record corresponds to the authorization record from among the one or more authorization records comprises: determining that the value associated with the first key field of the clearing record matches the value associated with the first key field of the authorization record; and determining that the value associated with the second key field of the clearing record does not match the value associated with the second key field of the authorization record, the program instructions being further configured to cause the at least one processor to: determine that the clearing record partially matches the authorization record based on determining that the value associated with the first key field of the clearing record matches the value associated with the first key field of the authorization record and that the value associated with the second key field of the clearing record does not match the value associated with the second key field of the authorization record.

Clause 20: The computer program product of any of clauses 16-19, wherein generating the updated clearing record comprises: providing the clearing record and the authorization record as input to a machine learning model; generating a prediction associated with a confidence score that the clearing record matches the authorization record based on providing the clearing record and the authorization record as the input to the machine learning model; and updating the clearing record based on the confidence score.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS AND APPENDICES

Additional advantages and details of the disclosure are explained in greater detail below with reference to the exemplary embodiments or aspects that are illustrated in the accompanying schematic figures, in which:

FIG. 1 is a diagram of a non-limiting embodiment or aspect of an example environment for determining correspondence of non-indexed records;

FIG. 2 is a diagram of a non-limiting embodiment or aspect of components of one or more devices and/or one or more systems of FIG. 1;

FIG. 3 is a flowchart of a non-limiting embodiment or aspect of a process for determining correspondence of non-indexed records;

FIG. 4 is an operational diagram of a non-limiting embodiment or aspect of a process for determining correspondence of non-indexed records;

FIG. 5 is an operational diagram of a non-limiting embodiment or aspect of a first process for use in a process for determining correspondence of non-indexed records; and

FIG. 6 is an operational diagram of a non-limiting embodiment or aspect of a second process for use in a process for determining correspondence of non-indexed records.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” and “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may refer to one or more types of identifiers associated with an account (e.g., a PAN associated with an account, a card number associated with an account, a payment card number associated with an account, a token associated with an account, and/or the like). In some non-limiting embodiments or aspects, an issuer may provide an account identifier (e.g., a PAN, a token, and/or the like) to a user (e.g., an accountholder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments or aspects, the account identifier may be an original account identifier, where the original account identifier was provided to a user at the creation of the account associated with the account identifier. In some non-limiting embodiments or aspects, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier that is used as a substitute or replacement for another account identifier, such as a PAN. Tokens may be associated with a PAN or other original account identifier in one or more data structures (e.g., one or more databases and/or the like) such that they may be used to conduct a payment transaction without directly using the original account identifier. In some non-limiting embodiments or aspects, an original account identifier, such as a PAN, may be associated with a plurality of tokens for different individuals or purposes. In some non-limiting embodiments or aspects, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like.

As used herein, the term “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction processing system” may refer to one or more computer systems operated by or on behalf of a transaction service provider, such as a transaction processing system executing one or more software applications. A transaction processing system may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “electronic wallet,” “electronic wallet mobile application,” and “digital wallet” may refer to one or more electronic devices including one or more software applications configured to facilitate and/or conduct transactions (e.g., payment transactions, electronic payment transactions, and/or the like). For example, an electronic wallet may include a user device (e.g., a mobile device) executing an application program, server-side software, and/or databases for maintaining and providing data to be used during a payment transaction to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the terms “client” and “client device” may refer to one or more computing devices, such as processors, storage devices, and/or similar computer components, that access a service made available by a server. In some non-limiting embodiments or aspects, the term “client device” may refer to one or more devices that facilitate payment transactions, such as POS devices and/or POS systems used by a merchant. In some non-limiting embodiments or aspects, a client device may include an electronic device configured to communicate with one or more networks and/or facilitate payment transactions such as, but not limited to, one or more desktop computers, one or more portable computers (e.g., tablet computers), one or more mobile devices (e.g., cellular phones, smartphones, personal digital assistants (PDAs), wearable devices, such as watches, glasses, lenses, and/or clothing, and/or the like), and/or other like devices. Moreover, the term “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, “clearing record” may refer to a communicated data object sent from an acquirer system to a transaction processing system, which may be communicated to an issuer system modified or unmodified, and which may be associated with a presentment, dispute, dispute response, acquirer-initiated pre-arbitration, reversal, adjustment, and/or the like, in a format necessary to clear a transaction. “Clearing” may refer to the process of a transaction processing system of receiving a clearing record from an acquirer system and communicating the clearing record to an issuer system to complete a transaction (e.g., credit card transaction), reverse a transaction, or process a fee collection transaction. “Settlement” may refer to the reporting and funds transfer of amounts owed by one entity account to another, or to the transaction processing system, as a result of clearing. As used herein, “authorization record” may refer to a communicated data object sent from an acquirer system to an issuer system, directly or indirectly (e.g., via a transaction processing system), which may be associated with an authorized amount for payment from one entity account to another. Clearing records, when received, may be matched to an authorized record for settlement of a transaction.

By virtue of implementation of the systems, methods, and computer program products described herein, systems may be implemented that enable an issuer institution to more quickly and accurately determine whether an authorization record corresponds to a clearing record. For example, systems may be implemented as described herein to determine whether a clearing record corresponds to an authorization record where an approved transaction amount specified in the authorization record differs from an approved transaction amount specified in a clearing record (e.g., where a tip was added to the approved transaction amount that is greater than is permitted by the issuer institution). As a result, these systems may more accurately determine that an authorization record corresponds to a clearing record. This, in turn, may reduce the amount of time such a system may need to process the payment transaction.

Additionally, or alternatively, the issuer institution involved in the payment transaction may be able to forego processing the payment transaction as a force-post payment transaction based on determining that a clearing record corresponds to an authorization record, and subsequently may avoid issuing a chargeback, thereby reducing the consumption of network resources (e.g., computer processing capacity, time, bandwidth, etc.).

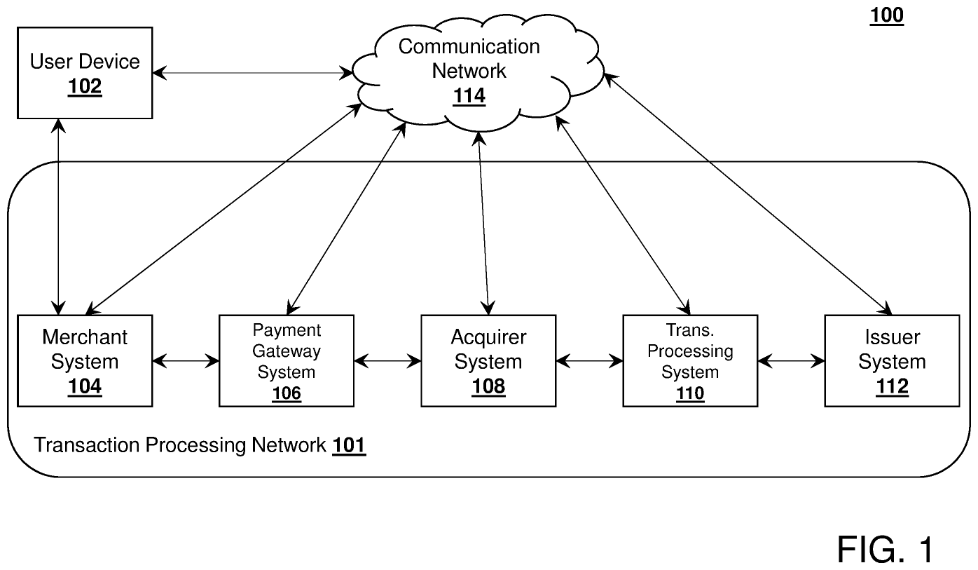

Referring now to FIG. 1, provided is a diagram of an example environment 100 in which devices, systems, methods, and/or products described herein may be implemented. As shown in FIG. 1, environment 100 includes transaction processing network 101, user device 102, merchant system 104, payment gateway system 106, acquirer system 108, transaction processing system 110, issuer system 112, and/or communication network 114. Transaction processing network 101, user device 102, merchant system 104, payment gateway system 106, acquirer system 108, transaction processing system 110, and/or issuer system 112 may interconnect (e.g., establish a connection to communicate, and/or the like) via wired connections, wireless connections, or a combination of wired and wireless connections.

User device 102 may include one or more devices configured to be in communication with merchant system 104, payment gateway system 106, acquirer system 108, transaction processing system 110, and/or issuer system 112 via communication network 114. For example, user device 102 may include a payment device, a smartphone, a tablet, a laptop computer, a desktop computer, and/or the like. User device 102 may be configured to transmit and/or receive data to and/or from merchant system 104 via an imaging system and/or a short-range wireless communication connection (e.g., a near-field communication (NFC) connection, a radio frequency identification (RFID) communication connection, a Bluetooth® communication connection, and/or the like). In some non-limiting embodiments or aspects, user device 102 may be associated with a user (e.g., an individual operating a device).

Merchant system 104 may include one or more devices configured to be in communication with user device 102, payment gateway system 106, acquirer system 108, transaction processing system 110, and/or issuer system 112 via communication network 114. For example, merchant system 104 may include one or more servers, one or more groups of servers, one or more client devices, one or more groups of client devices, and/or the like. In some non-limiting embodiments or aspects, merchant system 104 may include a point-of-sale (POS) device. In some non-limiting embodiments or aspects, merchant system 104 may be associated with a merchant as described herein.

Payment gateway system 106 may include one or more devices configured to be in communication with user device 102, merchant system 104, acquirer system 108, transaction processing system 110, and/or issuer system 112 via communication network 114. For example, payment gateway system 106 may include one or more servers, one or more groups of servers, and/or the like. In some non-limiting embodiments or aspects, payment gateway system 106 may be associated with a payment gateway as described herein.

Acquirer system 108 may include one or more devices configured to be in communication with user device 102, merchant system 104, payment gateway system 106, transaction processing system 110, and/or issuer system 112 via communication network 114. For example, acquirer system 108 may include one or more servers, one or more groups of servers, and/or the like. In some non-limiting embodiments or aspects, acquirer system 108 may be associated with an acquirer as described herein.

Transaction processing system 110 may include one or more devices configured to be in communication with user device 102, merchant system 104, payment gateway system 106, acquirer system 108, and/or issuer system 112 via communication network 114. For example, transaction processing system 110 may include one or more servers (e.g., a transaction processing server), one or more groups of servers, and/or the like. In some non-limiting embodiments or aspects, transaction processing system 110 may be associated with a transaction service provider as described herein.

Issuer system 112 may include one or more devices configured to be in communication with user device 102, merchant system 104, payment gateway system 106, acquirer system 108, and/or transaction processing system 110 via communication network 114. For example, issuer system 112 may include one or more servers, one or more groups of servers, and/or the like. In some non-limiting embodiments or aspects, issuer system 112 may be associated with an issuer institution that issued a payment account and/or instrument (e.g., a credit account, a debit account, a credit card, a debit card, and/or the like) to a user (e.g., a user associated with user device 102 and/or the like).

In some non-limiting embodiments or aspects, transaction processing network 101 may include one or more systems in a communication path for processing a transaction. For example, transaction processing network 101 may include merchant system 104, payment gateway system 106, acquirer system 108, transaction processing system 110, and/or issuer system 112 in a communication path (e.g., a communication path, a communication channel, a communication network, and/or the like). For example, transaction processing network 101 may process (e.g., initiate, conduct, authorize, and/or the like) an electronic payment transaction via the communication path between merchant system 104, payment gateway system 106, acquirer system 108, transaction processing system 110, and/or issuer system 112.

Communication network 114 may include one or more wired and/or wireless networks. For example, communication network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

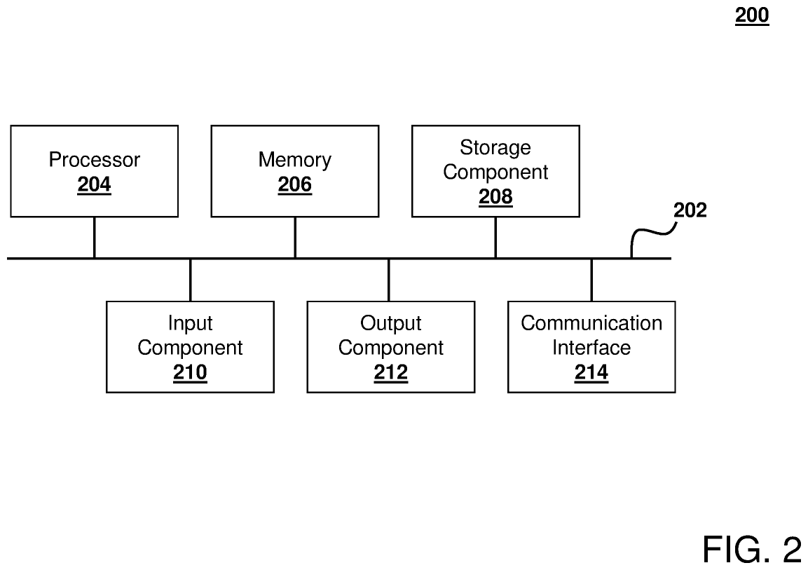

Referring now to FIG. 2, illustrated is a diagram of example components of device 200. Device 200 may correspond to one or more devices of transaction processing network 101, one or more devices of user device 102 (e.g., one or more devices of a system of user device 102), one or more devices of merchant system 104, one or more devices of the payment gateway system 106, one or more devices of acquirer system 108, one or more devices of transaction processing system 110, one or more devices of the issuer system 112, and/or one or more devices of the communication network 114. In some non-limiting embodiments or aspects, one or more devices of user device 102, one or more devices of merchant system 104, one or more devices of payment gateway system 106, one or more devices of acquirer system 108, one or more devices of transaction processing system 110, one or more devices of issuer system 112, and/or one or more devices of the communication network 114 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes, as described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include clearing record data, input data, output data, transaction data, account data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

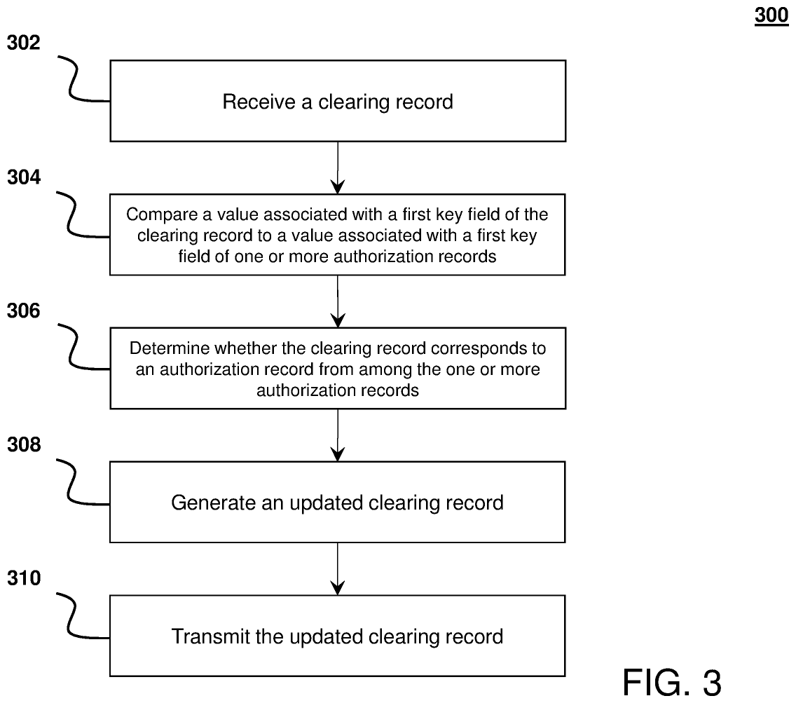

Referring now to FIG. 3, illustrated is a flowchart of a non-limiting aspect or embodiment of a process 300 for determining correspondence of non-indexed records. In some non-limiting embodiments or aspects, one or more of the functions described with respect to process 300 may be performed (e.g., completely, partially, etc.) by transaction processing system 110. In some non-limiting embodiments or aspects, one or more of the steps of process 300 may be performed (e.g., completely, partially, and/or the like) by another device or a group of devices separate from and/or including transaction processing system 110, such as user device 102, merchant system 104, payment gateway system 106, acquirer system 108, and/or issuer system 112.

As shown in FIG. 3, at step 302, process 300 may include receiving a clearing record. For example, transaction processing system 110 may receive a clearing record. In such an example, transaction processing system 110 may receive the clearing record from acquirer system 108. In some non-limiting embodiments or aspects, a clearing record may be associated with a payment transaction. In some non-limiting embodiments or aspects, a clearing record may be associated with a payment transaction involving and/or initiated by a user associated with user device 102 and a merchant associated with merchant system 104. In some non-limiting embodiments or aspects, a clearing record may include one or more key fields (e.g., transaction data fields). A transaction record (e.g., clearing record, authorization record) may include a plurality of data fields, such as transaction data fields. A transaction data field may include a data field that specifies a parameter of the transaction record. Examples of transaction data fields may include, but are not limited to, payment device identifier, transaction type (e.g., credit, debit, etc.), payment account type (e.g., debit account, credit account, etc.), payment device entry type (e.g., swiped, keyed, etc.), payment device expiration date, transaction amount, transaction identifier, and/or the like. In some non-limiting embodiments or aspects, a clearing record may be associated with one or more payment transactions that were completed in a payment processing network.

In some non-limiting embodiments or aspects, transaction processing system 110 may receive a clearing batch file. For example, transaction processing system 110 may receive a clearing batch file from an acquirer system 108. In some non-limiting embodiments or aspects, a clearing batch file may be an electronic file that includes a plurality of clearing records, where each clearing record of the clearing batch file is associated with a payment transaction. For example, a clearing batch file may include a plurality of clearing records, where each clearing record of the clearing batch file is associated with a payment transaction of one or more payment transactions aggregated by acquirer system 108. In such an example, acquirer system 108 may aggregate the plurality of clearing records over a period of time (e.g., a day, a week, and/or the like). In some non-limiting embodiments or aspects, transaction processing system 110 may generate and transmit a clearing batch file. For example, transaction processing system 110 may generate and transmit a clearing batch file based on transaction processing system 110 receiving a plurality of clearing records. In such an example, the plurality of clearing records may be associated with payment transactions involving one or more merchant systems 104 and one or more user devices 102.

In some non-limiting embodiments or aspects, a payment transaction may be associated with an authorization record. For example, a payment transaction may be associated with an authorization record based on transaction processing system 110 generating the authorization record. In such an example, transaction processing system 110 may generate the authorization record based on transaction processing system 110 receiving transaction data associated with the payment transaction. In some non-limiting embodiments or aspects, transaction processing system 110 may receive transaction data associated with a payment transaction from merchant system 104. For example, transaction processing system 110 may receive transaction data associated with a payment transaction from merchant system 104 based on user device 102 initiating the payment transaction at merchant system 104.

In some non-limiting embodiments or aspects, transaction processing system 110 may receive an authorization record. For example, transaction processing system 110 may receive an authorization record from issuer system 112. In some non-limiting embodiments or aspects, transaction processing system 110 may receive an authorization record from issuer system 112 based on initiation of a payment transaction associated with the authorization record. For example, transaction processing system 110 may receive an authorization record from issuer system 112 based on initiation of a payment transaction associated with the authorization record at merchant system 104 by user device 102. In such an example, issuer system 112 may be involved in the payment transaction. In some non-limiting embodiments or aspects, an authorization record may comprise one or more key fields, the one or more key fields each associated with a value. For example, the authorization record may comprise one or more key fields, where the one or more key fields are associated with (e.g., may partially and/or completely correspond to) one or more key fields of a clearing record, as described herein.

In some non-limiting embodiments or aspects, transaction processing system 110 may normalize one or more clearing records. For example, transaction processing system 110 may normalize one or more clearing records of a plurality of clearing records of a clearing batch file. In some non-limiting embodiments or aspects, transaction processing system 110 may normalize one or more clearing records based on a clearing record template, which may be an electronic file including a set of predetermined data field format definitions for the key fields of a clearing record. For example, transaction processing system 110 may normalize the one or more clearing records based on a clearing record template associated with associated with issuer system 112. In some non-limiting embodiments or aspects, transaction processing system 110 may normalize one or more clearing records based on transaction processing system 110 converting a value associated with one or more key values of the one or more clearing records to an updated value. For example, transaction processing system 110 may normalize the one or more clearing records based on transaction processing system 110 converting a value associated with one or more key values of the one or more clearing records to an updated value based on the clearing record template. In such an example, a transaction processing system 110 may convert a transaction amount associated with a key value of a clearing record from “$10.45” to “1045”.

As shown in FIG. 3, at step 304, process 300 may include comparing a value associated with a first key field of the clearing record to a value associated with a first key field of one or more authorization records. For example, transaction processing system 110 may compare a value associated with a first key field of the clearing record to a value associated with a first key field of one or more authorization records. In some non-limiting embodiments or aspects, a first key field of a clearing record may correspond to a first key field of the one or more authorization records. For example, a first key field of a clearing record may correspond to a first key field of one or more authorization records based on both the first key field of the clearing record and the first key field of the one or more authorization records specifying a key field (e.g., a transaction identifier of at least one payment transaction, a transaction amount of a payment transaction, a payment account type of a payment transaction, and/or the like) of one or more key fields, as described herein.

In some non-limiting embodiments or aspects, transaction processing system 110 may compare a value associated with a first key field of a clearing record to a value associated with a first key field of one or more authorization records based on transaction processing system 110 receiving the clearing record. For example, transaction processing system 110 may compare a value associated with a first key field of the clearing record to a value associated with a first key field of one or more authorization records based on transaction processing system 110 receiving the clearing record from acquirer system 108. In another example, transaction processing system 110 may compare a value associated with a first key field of the clearing record to a value associated with a first key field of one or more authorization records based on transaction processing system 110 receiving the clearing record in a clearing batch file. In such an example, transaction processing system 110 may receive the clearing batch file from acquirer system 108. In some non-limiting embodiments or aspects, transaction processing system 110 may compare a value associated with a first key field of a clearing record to a value associated with a first key field of one or more authorization records based on transaction processing system 110 determining that the first key field of the clearing record corresponds to the first key field of the one or more authorization records.

In some non-limiting embodiments or aspects, transaction processing system 110 may compare a plurality of values associated with a plurality of key fields of a clearing record to a plurality of values associated with a plurality of key fields of one or more authorization records. For example, transaction processing system 110 may compare a plurality of values associated with a plurality of key fields of a clearing record included in a clearing batch file to a plurality of values associated with a plurality of key fields of one or more authorization records. In some non-limiting embodiments or aspects, transaction processing system 110 may compare a plurality of values associated with a plurality of key fields of a clearing record to a plurality of values associated with a plurality of key fields of one or more authorization records based on transaction processing system 110 determining whether one or more values associated with one or more key fields of the clearing record are associated with (e.g., match, correspond to, and/or the like) one or more values associated with one or more key fields of one or more authorization records. For example, transaction processing system 110 may determine that a first value associated with a first key field of a clearing record is associated with a first value associated with a first key field of an authorization record. In such an example, transaction processing system 110 may compare one or more values associated with one or more key fields (e.g., different key fields from the first key field) of the clearing record to one or more values associated with one or more key fields (e.g., different key fields from the first key field) of the one or more authorization records. In such an example, transaction processing system 110 may determine that the one or more values associated with the key fields of the clearing record that were compared to the one or more values associated with the key fields of the one or more authorization records may correspond to one another based on transaction processing system 110 determining that the first value of the first key field of the clearing record is associated with the first value of the first key field of the one or more authorization records.

In some non-limiting embodiments or aspects, a clearing record and/or one or more authorization records may be associated with one or more payment transactions that were authorized in a payment transaction processing network. For example, a clearing record and/or one or more authorization records may be associated with one or more payment transactions that were processed in a payment transaction processing network by transaction processing system 110. In some non-limiting embodiments or aspects, an authorization record may be associated with and/or include transaction data associated with a payment transaction. For example, an authorization record may be associated with and/or include transaction data associated with a payment transaction involving user device 102 and merchant system 104.

As shown in FIG. 3, at step 306, process 300 may include determining whether the clearing record corresponds to an authorization record from among the one or more authorization records. For example, transaction processing system 110 may determine whether a clearing record corresponds to an authorization record from among the one or more authorization records. In such an example, transaction processing system 110 may determine whether the clearing record corresponds to the authorization record from among the one or more authorization records based on transaction processing system 110 comparing one or more values associated with one or more key fields of the clearing record to one or more values associated with one or more key fields of the one or more authorization records.

In one example, transaction processing system 110 may determine whether a clearing record corresponds to an authorization record from among one or more authorization records based on transaction processing system 110 determining that a value associated with a first key field of the clearing record matches a value associated with a first key field of an authorization record. In such an example, transaction processing system 110 may also determine that the clearing record corresponds to the authorization record based on transaction processing system 110 determining that a value associated with a second key field of the clearing record does not match a value associated with a second key field of the authorization record. In some non-limiting embodiments or aspects, transaction processing system 110 may determine that a clearing record partially matches an authorization record based on transaction processing system 110 determining that a value associated with a first key field of a clearing record matches a value associated with a first key field of the authorization record and that a value associated with a second key field of a clearing record does not match a value associated with a second key field of the authorization record.

In an example, transaction processing system 110 may determine whether a clearing record corresponds to an authorization record from among one or more authorization records based on transaction processing system 110 determining that a value associated with a first key field of the clearing record matches a value associated with a first key field of the authorization record. In such an example, transaction processing system 110 may also determine that a value associated with a second key field of the clearing record matches a value associated with the second key field of the authorization record. In some non-limiting embodiments or aspects, transaction processing system 110 may determine that a clearing record matches an authorization record based on transaction processing system 110 determining that a value associated with a first key field of the clearing record matches a value associated with a first key field of the authorization record, and that a value associated with a second key field of the clearing record matches a value associated with a second key field of the authorization record.

In an example, transaction processing system 110 may determine whether a clearing record corresponds to an authorization record from among one or more authorization records based on transaction processing system 110 determining that a value associated with a first key field of a clearing record does not match a value associated with a first key field of an authorization record. In such an example, transaction processing system 110 may also determine that a value associated with a second key field of the clearing record does not match a value associated with a second key field of the authorization record. In some non-limiting embodiments or aspects, transaction processing system 110 may determine that the clearing record does not match the authorization record based on transaction processing system 110 determining that a value associated with a first key field of the clearing record does not match a value associated with a first key field of the authorization record, and that the value associated with a second key field of the clearing record does not match a value associated with a second key field of the authorization record.

As shown in FIG. 3, at step 308, process 300 may include generating an updated clearing record. For example, transaction processing system 110 may generate an updated clearing record, e.g., a clearing record having modified and/or appended data. In some non-limiting embodiments or aspects, transaction processing system 110 may generate the updated clearing record based on transaction processing system 110 determining that the clearing record corresponds to one or more authorization records. For example, transaction processing system 110 may generate the updated clearing record based on transaction processing system 110 determining that the clearing record does not match, partially matches, and/or matches one or more authorization records.

In some non-limiting embodiments or aspects, transaction processing system 110 may provide a clearing record and an authorization record as input to a machine learning model. For example, transaction processing system 110 may provide the clearing record and the authorization record as input to the machine learning model based on transaction processing system 110 determining that the clearing record corresponds to the authorization record. In such an example, transaction processing system 110 may generate a prediction (e.g., an output representative of a likelihood of a clearing record matching an authorization record) based on transaction processing system 110 providing the clearing record and the authorization record as input to the machine learning model. The prediction may be associated with a confidence score (e.g., a score indicating a likelihood that that a clearing record matches and/or partially matches an authorization record). In some non-limiting embodiments or aspects, transaction processing system 110 may generate an updated clearing record based on a confidence score. In some non-limiting embodiments or aspects, transaction processing system 110 may generate an updated clearing record based on transaction processing system 110 appending a confidence score to the clearing record. In some non-limiting embodiments or aspects, transaction processing system 110 may generate an updated clearing record based on transaction processing system 110 appending an original transaction amount of the authorization record to a clearing record. For example, transaction processing system 110 may append an original transaction amount of an authorization record to a clearing record based on transaction processing system 110 determining that the authorization record matches and/or partially matches the clearing record. In some non-limiting embodiments or aspects, transaction processing system 110 may generate an updated clearing record based on transaction processing system 110 appending a transaction identifier of an authorization record to the clearing record. For example, transaction processing system 110 may generate a clearing record based on transaction processing system 110 appending a transaction identifier of an authorization record to the clearing record based on transaction processing system 110 determining that the authorization record matches and/or partially matches the clearing record.

In some non-limiting embodiments or aspects, transaction processing system 110 may generate an updated clearing batch file, e.g., a clearing batch file including one or more updated clearing records and/or one or more added or removed clearing records. For example, transaction processing system 110 may generate an updated clearing batch file based on transaction processing system 110 determining that a clearing record included in the clearing batch file corresponds to one or more authorization records. In some non-limiting embodiments or aspects, transaction processing system 110 may generate the updated clearing batch file based on a clearing batch file received by transaction processing system 110 and one or more updated clearing records generated by transaction processing system 110.

In some non-limiting embodiments or aspects, transaction processing system 110 may generate an updated clearing record based on transaction processing system 110 including a merchant transaction pattern and/or a confidence score with a clearing record. A merchant transaction pattern may include one or more trends, arrangements, changes, inclinations, and/or ranges of values of transaction data fields correlated with a merchant, and may be derived by analyzing historical transactions associated with a given merchant. For example, transaction processing system 110 may provide the clearing record and one or more authorization records to a machine learning model. In some non-limiting embodiments or aspects, transaction processing system 110 may generate a prediction associated with a merchant transaction pattern (e.g., pattern of values of key fields of historical clearing records and/or authorization records) and/or a confidence score based on providing the clearing record and the one or more authorization records as an input to the machine learning model. For example, transaction processing system 110 may generate a prediction associated with a merchant transaction pattern and/or a confidence score based on providing the clearing record and the one or more authorization records as an input to the machine learning model where the merchant transaction pattern is associated with one or more patterns of a merchant's historical transaction data (e.g., a clearing delay pattern associated with a period of time for clearing a payment transaction, a fraud transaction frequency pattern, and/or the like). In some non-limiting embodiments or aspects, transaction processing system 110 may update the clearing record based on the merchant transaction pattern and/or the confidence score. For example, transaction processing system 110 may update the clearing record based on the merchant transaction pattern and/or the confidence score based on transaction processing system 110 including the merchant transaction pattern and/or the confidence score in an updated clearing record.

In some non-limiting embodiments or aspects, transaction processing system 110 may update the clearing record to provide an updated clearing record based on transaction processing system 110 determining that the clearing record does not match one or more authorization records. For example, transaction processing system 110 may update the clearing record based on transaction processing system 110 determining that the clearing record does not match one or more authorization records and transaction processing system 110 may retrieve a merchant identifier, an acquirer identifier, and/or transaction data associated with a payment transaction. In such an example, the merchant identifier, the acquirer identifier, and the transaction data for the clearing record may be associated with a clearing record that transaction processing system 110 determined did not completely or partially match with one or more authorization records. In some non-limiting embodiments or aspects, transaction processing system 110 may provide the merchant identifier, the acquirer identifier, and the transaction data as input to a machine learning model configured to determine a merchant transaction pattern associated with a time delay of receiving clearing records and authorization records. For example, transaction processing system 110 may provide the merchant identifier, the acquirer identifier, and the transaction data as input to the machine learning model, and transaction processing system 110 may generate an output including a prediction based on providing the input to the machine learning model. For example, transaction processing system 110 may provide the merchant identifier, the acquirer identifier, and the transaction data as input to the machine learning model, and transaction processing system 110 may generate an output including a prediction based on providing the input to the machine learning model, the prediction associated with an estimated clearing delay (e.g., an estimated period of time from a point in time at which an authorization record is received and a point in time at which a clearing record is received, an estimated period of time associated with one or more parties to a payment transaction from a point in time at which an authorization record is received and a point in time at which a clearing record is received, and/or the like).

In some non-limiting embodiments or aspects, transaction processing system 110 may train the machine learning model configured to determine a merchant transaction pattern associated with a time delay of receiving clearing records and authorization records. For example, transaction processing system 110 may train the machine learning model based on historical transaction data. Transaction processing system 110 may train the machine learning model based on transaction processing system 110 providing the historical transaction data to the machine learning model. In such an example, the historical transaction data may include data associated with historical authorization records, data associated with historical clearing records, and/or data associated with an authorization volume and/or a clearing volume where the authorization volume and/or the clearing volume is for one or more parties to one or more payment transactions (e.g., one or more merchants, one or more acquirers, one or more issuers, and/or the like). In some non-limiting embodiments or aspects, the historical transaction data may include data associated with (e.g., indicating) a payment account type involved in a payment transaction (e.g., a credit account, a debit account, and/or the like), data associated with (e.g., indicating) a payment channel involved in a payment transaction (e.g., an indicator associated with in-person payment transactions, an indicator associated with e-commerce (e.g., online) payment transactions, and/or the like), data associated with a fraud risk score (e.g., a score associated with a determination of whether a payment transaction is a fraudulent payment transaction or not a fraudulent payment transaction), data associated with a merchant type (e.g., an indicator associated with a transit merchant, an indicator associated with a retail department store merchant, and/or the like), data associated with an acquirer behavior (e.g., an indicator that an acquirer processes payment transactions within a period of time, and/or the like), and/or the like.

In some non-limiting embodiments or aspects, transaction processing system 110 may determine whether the clearing record is associated with a force-post payment transaction. In one example, a clearing record associated with a force-post transaction may include a clearing record that has been determined to have been created based on a force-post transaction (e.g., a clearing record that has been created for clearing a transaction with no preceding authorization record). Additionally or alternatively, transaction processing system 110 may determine whether the clearing record is associated with a force-post payment transaction based on transaction processing system 110 comparing the output of the machine learning model to a threshold (e.g., a delay threshold associated with an amount of time associated with a force-post payment transaction). Where transaction processing system 110 determines that the output of the machine learning model (e.g., the estimated delay) satisfies the threshold, transaction processing system 110 may determine that the clearing record is not associated with a force-post payment transaction. Where transaction processing system 110 determines that the output of the machine learning model (e.g., the estimated delay) does not satisfy the threshold, transaction processing system 110 may determine that the clearing record is associated with a force-post payment transaction.

Additionally or alternatively, transaction processing system 110 may determine whether the clearing record is associated with a force-post payment transaction based on transaction processing system 110 comparing the probability that the clearing record is associated with a force-post payment transaction to a confidence threshold (e.g., a threshold associated with a likelihood that a clearing record is associated with a force-post payment transactions). Where transaction processing system 110 determines that the probability that the clearing record is associated with a force-post payment transaction satisfies the confidence threshold, transaction processing system 110 may determine that the clearing record associated with the transaction data is for a force-post payment transaction. Where transaction processing system 110 determines that the probability that the clearing record is associated with a force-post payment transaction does not satisfy the confidence threshold, transaction processing system 110 may determine that the clearing record associated with the transaction data is not for a force-post payment transaction.

In some non-limiting embodiments or aspects, transaction processing system 110 may update the clearing record based on transaction processing system 110 determining that the clearing record does not match one or more authorization records and transaction processing system 110 determining that the clearing record is not associated with a force-post payment transaction. For example, transaction processing system 110 may update the clearing record based on transaction processing system 110 determining that the clearing record does not match one or more authorization records and transaction processing system 110 determining that the clearing record is not associated with a force-post payment transaction based on transaction processing system 110 including an estimated clearing delay and confidence score with the clearing record. In some non-limiting embodiments or aspects, transaction processing system 110 may also update the clearing record to include the estimated clearing delay, as described herein.

In some non-limiting embodiments or aspects, transaction processing system 110 may determine whether the clearing record is associated with a permissible force-post payment transaction (e.g., a payment transaction that is a force-post payment transaction and is not determined to be a fraudulent payment transaction). For example, transaction processing system 110 may provide the merchant identifier, the acquirer identifier, and the transaction data as an input to a machine learning model configured to categorize a clearing record as being associated with a legitimate force-post payment transaction or impermissible force-post payment transaction. In such an example, transaction processing system 110 may generate an output based on transaction processing system 110 providing the input to the machine learning model. The output may include a prediction indicating whether the clearing record is associated with a permissible force-post payment transaction or an impermissible force-post payment transaction. In some non-limiting embodiments or aspects, transaction processing system 110 may update the clearing record based on an output of the machine learning model. For example, transaction processing system 110 may determine that the clearing record is for an impermissible force-post payment transaction, which may be a force-post payment transaction that a merchant is not authorized by a payer to conduct (e.g., a mistaken force-post payment transaction, a fraudulent force-post payment transaction, etc.), based on the output of the machine learning model. Transaction processing system 110 may update the clearing record to include an indication that the clearing record is for an impermissible force-post payment transaction. In some non-limiting embodiments or aspects, transaction processing system 110 may determine that the clearing record is for a permissible force-post payment transaction based on the output of the machine learning model and transaction processing system 110 may update the clearing record to include an indication that the clearing record is for a permissible force-post payment transaction. In some non-limiting embodiments or aspects, transaction processing system 110 may provide the updated clearing record to acquirer system 108. For example, transaction processing system 110 may provide the updated clearing record to acquirer system 108 based on transaction processing system 110 determining that the clearing record is not associated with a permissible force-post payment transaction. In such an example, transaction processing system 110 may determine that the clearing record is not associated with a permissible force-post payment transaction based on the output of the machine learning model.

In some non-limiting embodiments or aspects, transaction processing system 110 may train the machine learning model. For example, transaction processing system 110 may train the machine learning model based on transaction processing system 110 providing historical transaction data to the machine learning model. In such an example, the historical transaction data may include data associated with historical authorization records, data associated with historical clearing records, data associated with force-post payment transactions for a merchant that indicates the frequency with which a merchant submits force-post payment transactions, data associated with force-post payment transactions for different merchants that indicates the frequency with which the different merchants submit force-post payment transactions, data associated with a merchant that indicates that the merchant does not submit force-post payment transactions, data associated with a merchant that indicates that the merchant is associated with a high fraud rate for force-post payment transactions (e.g., that force-post payment transaction submitted by the merchant have a probability of being fraudulent that is greater than a threshold probability), and/or the like.

As shown in FIG. 3, at step 310, process 300 may include transmitting the updated clearing record. For example, transaction processing system 110 may transmit the updated clearing record to acquirer system 108. In such an example, transaction processing system 110 may transmit the updated clearing record to the acquirer system 108 that transmitted the clearing record to transaction processing system 110. In some non-limiting embodiments or aspects, transaction processing system 110 may transmit the updated clearing record to issuer system 112. For example, transaction processing system 110 may transmit the updated clearing record to issuer system 112 based on transaction processing system 110 determining that the clearing record and/or the one or more authorization records that correspond to the clearing record are associated with issuer system 112. In such an example, issuer system 112 may be involved in the payment transaction that is associated with the clearing record and/or the one or more authorization records.

In some non-limiting embodiments or aspects, transaction processing system 110 may transmit an updated clearing batch file to acquirer system 108. For example, transaction processing system 110 may transmit an updated clearing batch file to acquirer system 108, where acquirer system 108 transmitted the clearing batch file to transaction processing system 110. In some non-limiting embodiments or aspects, transaction processing system 110 may transmit the updated clearing batch file to issuer system 112. For example, transaction processing system 110 may transmit the updated clearing batch file to issuer system 112 based on transaction processing system 110 determining that the clearing batch file and/or the one or more authorization records that correspond to clearing records included in the clearing batch file are associated with issuer system 112. In such an example, issuer system 112 may be involved in the payment transaction that is associated with one or more clearing records and/or the one or more authorization records that are associated with the clearing batch file.

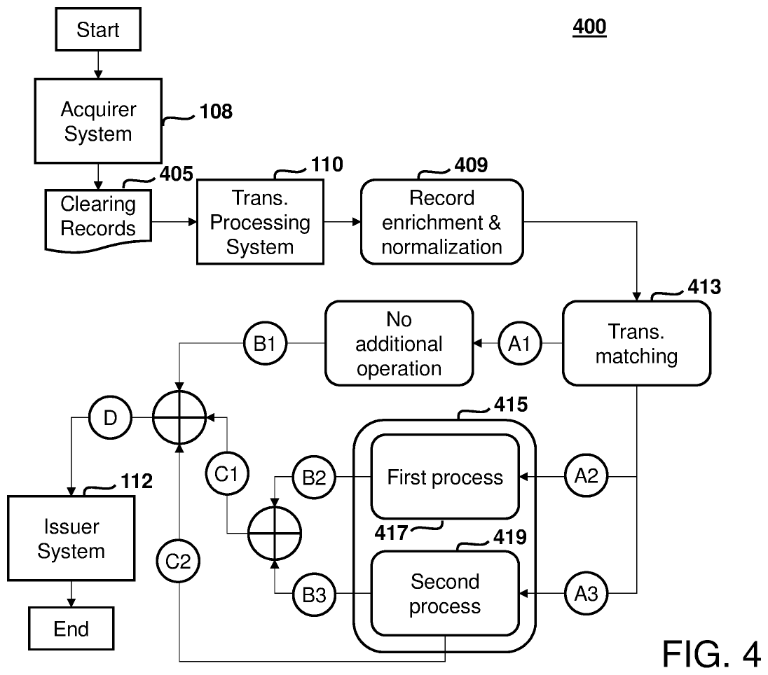

Referring to FIG. 4, provided is an operational diagram of a process 400 for determining correspondence of non-indexed records. The process may include an acquirer system 108 consolidating clearing records 405 to send to a transaction processing system 110 of a transaction service provider. The transaction processing system 110 may receive the clearing records 405 from the acquirer system 108. In step 409, the clearing records 405 may be normalized and/or enriched. Normalization may include the reformatting of key fields of clearing records according to a predetermined set of key field formats, such as to allow a clearing record to be compared to authorization records more precisely. Enrichment may refer to the modification and/or addition of data to a clearing record. For example, the transaction processing system 110 may normalize key fields of the clearing records 405, including, but not limited to, transaction amount, transaction ID, merchant name, and/or the like. Additionally or alternatively, the transaction processing system 110 may enrich the clearing records 405 with additional intelligence, including, but not limited to, providing a merchant identifier for one or more clearing records 405.

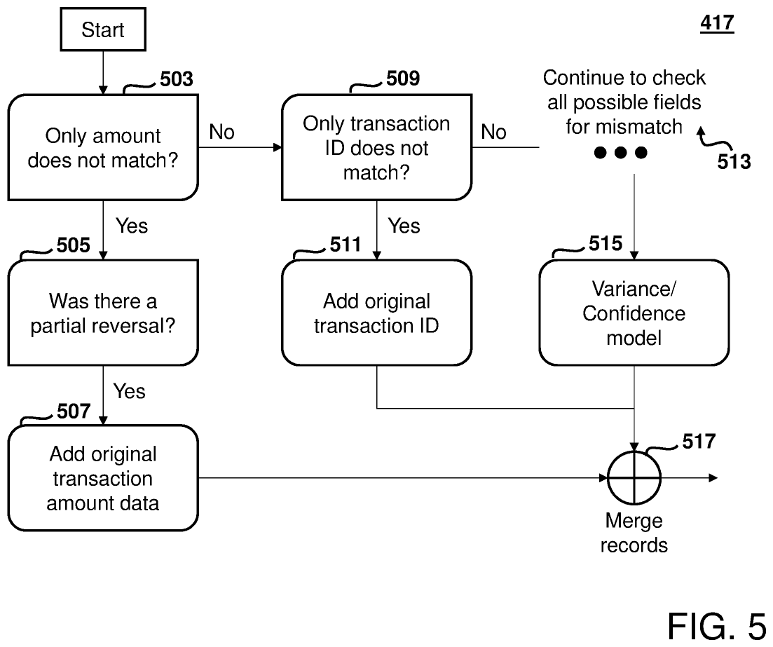

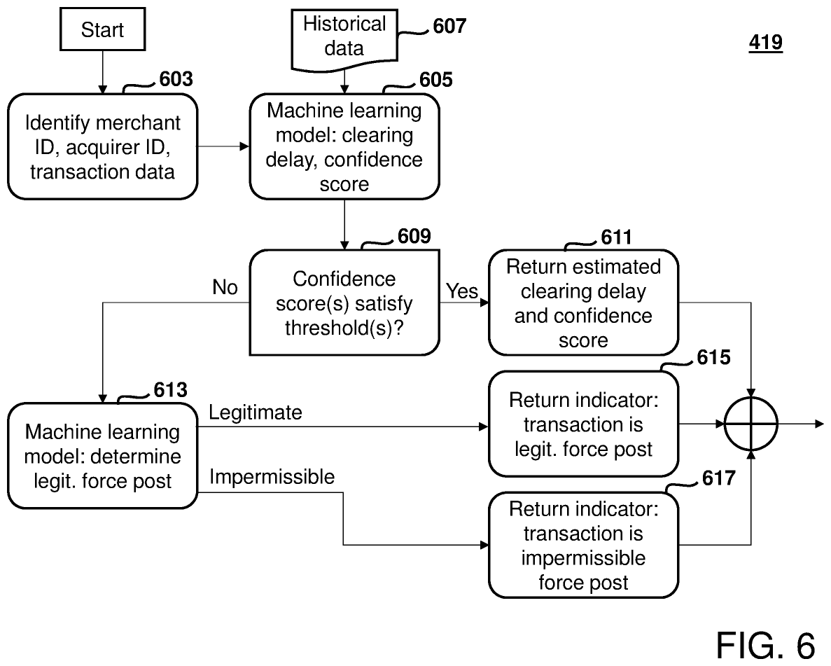

In step 413, a transaction matching process may be initiated. For example, the transaction processing system 110 may initiate transaction matching for each clearing record of the set of clearing records 405, e.g., using a transaction matching module. In response to determining that a clearing record matches an authorization record (outcome A1), the transaction processing system may take no additional operation. A match may include, e.g., the clearing record and authorization record having matching transaction identifiers, merchant identifiers, and/or transaction amounts. In response to determining that a clearing record is a partial match with at least one authorization record (outcome A2), the transaction processing system 110 may execute a first process 417 of an assisted transaction matching module 415, which may update a clearing record to match an authorization record. See FIG. 5 for additional disclosure on the first process 417. In response to determining that a clearing record does not match any authorization records (outcome A3), the transaction processing system 110 may execute a second process 419 of an assisted transaction matching module 415, which may update a clearing record to match an authorization record. See FIG. 6 for additional disclosure on the second process 419.

In outputs B1, B2, and B3, matched clearing records and authorization records may be provided, e.g., by the transaction processing system 110. B2 and B3 may include updated clearing records matched with authorization records that are enriched with confidence scores generated by machine learning models used to establish the match between a given clearing record and authorization record. The transaction processing system 110 may merge output B2 and B3 to form a combined output C1 associated with clearing records and authorization records matched using the assisted transaction matching module 415. The second process 419 may further output clearing records for which no matching authorization record may be identified, in output C2. All outputs from the processes 417,419 of the assisted transaction matching module 415, e.g., output C1 and output C2, may be merged by the transaction processing system 110, including with clearing records and authorization records that were able to be matched without further comparative analysis, in output B1. Output D may include a compiled set of clearing records, which includes outputs B1, C1, and C2. Output D may be communicated by the transaction processing system 110 to the issuer system 112.

Referring to FIG. 5, provided is an operational diagram of a first process 417 for determining correspondence of non-indexed records. The first process 417 may be executed, for example, when one or more partial matches are identified between one or more of the clearing records 405 and one or more authorization records (e.g., one or more key fields, but not all key fields, include the same values). In some non-limiting embodiments or aspects, one or more of the functions described with respect to the first process 417 may be performed (e.g., completely, partially, etc.) by transaction processing system 110. In some non-limiting embodiments or aspects, one or more of the steps of first process 417 may be performed (e.g., completely, partially, and/or the like) by another device or a group of devices separate from and/or including transaction processing system 110, such as user device 102, merchant system 104, payment gateway system 106, acquirer system 108, and/or issuer system 112.

In step 503, it may be determined whether only the transaction amount of a clearing record does not match an authorization record. For example, the transaction processing system 110 may determine whether a clearing record matches an authorization record in all key fields except transaction amount. If the clearing record matches an authorization record in all key fields except transaction amount, step 505 may be executed. If the clearing record does not match an authorization record in all key fields except transaction amount, step 509 may be executed.

In step 505, it may be determined if there was a partial reversal. For example, the transaction processing system 110 may determine if the difference in the amount of the transaction of the clearing record partially matched to the authorization record was due to a partial reversal of transaction amount. A partial reversal may include a transaction where a clearing record amount is less than the authorization record amount, so that the payer of the transaction pays less than the original amount authorized. The determination of a partial reversal may include a comparison of the clearing record amount to the authorization record amount, to determine if the clearing record amount is less than the authorization record amount. If the clearing record amount is less than the authorization record amount, indicating a partial reversal, step 507 may be executed.

In step 507, original transaction amount data may be added to the partially matched clearing record. For example, the transaction processing system 110 may update the partially matched clearing record, producing an updated clearing record, which may include data of the original transaction amount that was authorized prior to the partial reversal, which is associated with the disparity in transaction amount. In some non-limiting embodiments or aspects, the added data may be included in an existing clearing record key field or in an appended clearing record key field.

In step 509, it may be determined if only the transaction identifier of a clearing record does not match a given authorization record. For example, the transaction processing system 110 may determine if a clearing record matches an authorization record in all key fields except transaction identifier. If the clearing record matches an authorization record in all key fields except transaction identifier, step 511 may be executed. If the clearing record does not match an authorization record in all key fields except transaction identifier, step 513 may be executed.

In step 511, the original transaction identifier may be added to the partially matched clearing record. For example, the transaction processing system 110 may update the clearing record that matches an authorization record in all key fields except the transaction identifier to produce an updated clearing record, by including the transaction identifier of the authorization record in the data of the clearing record. In some non-limiting embodiments or aspects, the added data may be included in an existing clearing record key field or in an appended clearing record key field.

In step 513, the remaining key fields of the clearing record each may be evaluated for a mismatch with an authorization record. For example, the transaction processing system 110 may determine if a clearing record partially matches an authorization record, but differs in more than one key field. If multiple key fields do not match between a clearing record and an authorization record, step 515 may be executed.

In step 515, variance and confidence scores of clearing records may be determined using a machine-learning model. For example, the transaction processing system 110 may generate, for each clearing record processed in the first process 417, a variance limit and a confidence score based on the generated variance limit. The variance limit may be generated from a machine-learning model trained with historical authorization records and clearing records, and based on inputting a merchant and/or acquirer identifier associated with an analyzed clearing record to the machine-learning model. A variance limit may be a maximum or minimum value of variance in a key field of a clearing record and/or authorization record. In some non-limiting embodiments or aspects, the variance limit may be based on a historical (e.g., mean, median, etc. of past values) variance of transaction amounts (e.g., 5%) between clearing records and authorization records for a given merchant. In some non-limiting embodiments or aspects, the variance limit may be based on a historical variance of times (e.g., 7 days) between communication of clearing records and authorization records from acquirer systems. Based on a generated variance limit of a clearing record, a confidence score can be generated for the clearing record by comparing (i) the variance between a value of a key field of the clearing record and a value of a same key field of an authorization record, to (ii) the generated variance limit. The confidence score may be a value representative of how far within the variance limit the variance between the clearing record value(s) and authorization record value(s) are. Low variance within a variance limit may be assigned a high confidence score. High variance outside a variance limit may be assigned a low confidence score.

In step 517, the clearing records of steps 507, 511, and 515 may be merged. For example, the transaction processing system 110 may merge the clearing records of steps 507, 511, and 515 to form an output of the first process 417.

Referring to FIG. 6, provided is an operational diagram of a second process 419 for determining correspondence of non-indexed records. The second process 419 may be executed, for example, when no match is identified for one or more of the clearing records 405, vis-à-vis one or more authorization records. In some non-limiting embodiments or aspects, one or more of the functions described with respect to the second process 419 may be performed (e.g., completely, partially, etc.) by transaction processing system 110. In some non-limiting embodiments or aspects, one or more of the steps of second process 419 may be performed (e.g., completely, partially, and/or the like) by another device or a group of devices separate from and/or including transaction processing system 110, such as user device 102, merchant system 104, payment gateway system 106, acquirer system 108, and/or issuer system 112.

In step 603, for each clearing record for which no match was identified, a merchant identifier, acquirer identifier, and transaction data of the clearing record may be identified. For example, the transaction processing system 110 may identify the merchant identifier, acquirer identifier, and transaction data associated with the transaction of the clearing record, e.g., as stored in the key fields of the clearing record.

In step 605, estimated clearing delay and confidence scores for the input clearing records may be output from a machine learning model configured to determine a merchant transaction pattern associated with a time delay of receiving clearing records and authorization records. For example, the transaction processing system 110 may operate a machine learning model programmed and/or configured to be trained on historical transaction data 607 (e.g., authorization record data, clearing record data, etc.) to determine merchant transaction patterns of merchants. The machine learning model may, given an input of a merchant identifier, acquirer identifier, and/or other transaction data of a clearing record, generate an estimated time delay (e.g., a delay in time from clearing records being received relative to authorization records being received) that is associated with the merchant that originated the clearing record, and generate confidence scores for the unmatched clearing records. A confidence score may include a value indicative of the likelihood of the clearing record being a force-post payment transaction, based at least partly on the estimated time delay. A high confidence score may be indicative of a high likelihood of a clearing record not being associated with a force-post payment transaction. A high confidence score may result from a clearing record being associated with a merchant having a high estimated time delay for clearing, which may indicate that a matching authorization record was not identified due to high delay. A low confidence score may be indicative of a low likelihood of the clearing record being associated with a force-post payment transaction. A low confidence score may result from a clearing record being associated with a merchant having a low estimated time delay for clearing, which may indicate that a matching authorization record may not exist, as a matching authorization record would be more likely to be identified due to low delay.

In some non-limiting embodiments or aspects, the historical transaction data 607 may include data associated with (e.g., indicating) a payment account type involved in a payment transaction (e.g., a credit account, a debit account, and/or the like), data associated with (e.g., indicating) a payment channel involved in a payment transaction (e.g., an indicator associated with in-person payment transactions, an indicator associated with e-commerce (e.g., online) payment transactions, and/or the like), data associated with a fraud risk score (e.g., a score associated with a determination of whether a payment transaction is a fraudulent payment transaction or not a fraudulent payment transaction), data associated with a merchant type (e.g., an indicator associated with a transit merchant, an indicator associated with a retail department store merchant, and/or the like), data associated with an acquirer behavior (e.g., an indicator that an acquirer processes payment transactions within a period of time, and/or the like), and/or the like. By way of further example, the machine learning model may identify merchant transaction patterns according to the above historical transaction data 607, such as identifying: debit transactions may clear faster than credit transactions; in-person transactions may clear faster than e-commerce transactions; low-risk transactions may clear faster than high-risk transactions; transit merchants may clear faster than retail department store transactions; some acquirers may clear faster than other acquirers; and/or the like.

Further in step 605, the machine learning model may, after being trained on the historical transaction data 607, generate a prediction of how long the delay between authorization and clearing is likely to be for a merchant. The machine learning model may continually regenerate the estimates (e.g., re-train and re-execute the model) as additional data becomes available and is added to the historical transaction data 607 that may be used to train the machine learning model.

In step 609, it may be determined whether the output confidence scores of step 605 satisfy (e.g., meet and/or exceed) a predetermined threshold. For example, the transaction processing system 110 may be programmed and/or configured with a predetermined threshold confidence level. The predetermined threshold confidence level may be a higher value (e.g., greater than 50 on a scale of 0 to 100), such that false positives are infrequent and/or minimized. The transaction processing system 110 may determine, for each analyzed clearing record, whether the confidence score of the clearing record satisfies the predetermined threshold. If the predetermined threshold is satisfied by a clearing record's generated confidence score, step 611 may be executed. If the predetermined threshold is not satisfied by a clearing record's generated confidence score, step 613 may be executed.

In step 611, the estimated clearing delay and confidence score may be output from the second process 419. For example, the transaction processing system 110 may output the estimated clearing delay and confidence score for each clearing record having a confidence score that satisfied a predetermined threshold in step 609. In some non-limiting embodiments or aspects, the transaction processing system 110 may generate an updated clearing record by modifying and/or appending a key field of the clearing record to include the estimated clearing delay and the confidence score.

In step 613, a machine learning model configured to categorize a clearing record as being associated with a legitimate force-post payment transaction or impermissible force-post payment transaction may determine if a clearing record having a confidence score that did not satisfy the predetermined threshold is associated with a legitimate force-post payment transaction or not. For example, the transaction processing system 110 may execute a machine learning model that is trained on historical transaction data 607 and is configured to determine if a merchant and/or acquirer have a historical frequency of sending force-post payment transactions, indicating a likelihood to do so in connection with the clearing record. In some non-limiting embodiments or aspects, model features of the machine-learning model may include, but are not limited to, whether a merchant submits force-post payment transactions on a regular basis (which may be indicative of legitimate transaction behavior), whether similar merchants submit force-post payment transactions on a regular basis (which may be indicative of legitimate transaction behavior), whether a merchant has a high fraud rate on force-post payment transactions (which may be indicative of impermissible transaction behavior), and/or the like. The machine learning model of step 613, after being trained on historical transaction data 607, may receive an input of a clearing record and categorize the clearing record as being associated with a legitimate or impermissible force-post payment transaction.

For clearing records likely associated with legitimate force-post payment transactions, the machine learning model may return an indicator that the transaction associated with the clearing record is a legitimate force-post payment transaction, in step 615. For clearing records likely associated with impermissible force-post payment transactions, the machine learning model may return an indicator that the transaction associated with the clearing record is an impermissible force-post payment transaction, in step 617. In some non-limiting embodiments or aspects, the transaction processing system 110 may generate an updated clearing record by modifying and/or appending a key field of the clearing record to include the indicator of the clearing record being associated with a legitimate or impermissible force-post payment transaction. The clearing records of step 611,615, and 617 may then be merged to form a collective output of the second process 419.

Additionally or alternatively, an updated clearing record that includes an indicator of the clearing record being associated with an impermissible force-post payment transaction may be communicated back to the acquirer system 108 for remediation, by the transaction processing system 110, rather than being communicated to the issuer system 112 for posting of the transaction. In such an example, clearing records associated with impermissible force-post payment transactions may be removed and/or excluded (e.g., not merged with other clearing records) from an updated clearing batch file that may be communicated to the issuer system 112. Additionally or alternatively, an acquirer system 108 may receive an updated clearing record that was returned with an indicator that the clearing record was associated with an impermissible force-post payment transaction, while the associated force-post payment transaction was actually legitimate. The acquirer system 108 may review the legitimacy of the clearing record and resubmit a request for authorization of the associated transaction by sending an authorization record followed by a new clearing record, if the associated transaction is legitimate.

Although the above methods, systems, and computer program products have been described in detail for the purpose of illustration based on what is currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a clearing record comprising at least one key field, the clearing record associated with one or more payment transactions that were completed in a payment transaction processing network;
comparing, with at least one processor, a value associated with a first key field of the clearing record to a value associated with a first key field of one or more authorization records associated with one or more payment transactions that were authorized in the payment transaction processing network, the first key field of the clearing record corresponding to the first key field of the one or more authorization records, wherein the one or more authorization records are associated with an authorization request for a payment transaction of the one or more payment transactions;
determining, with at least one processor, that the clearing record corresponds to an authorization record from among the one or more authorization records based on comparing the value associated with the first key field of the clearing record to the value associated with the first key field of the one or more authorization records;
generating, with at least one processor, an updated clearing record based on determining that the clearing record corresponds to the authorization record; and
transmitting, with at least one processor, the updated clearing record.

2. The computer-implemented method of claim 1, wherein receiving the clearing record associated with the one or more payment transactions comprises:
receiving, with at least one processor, a clearing batch file comprising a plurality of clearing records for a plurality of payment transactions,
the computer-implemented method further comprising:
normalizing, with at least one processor, one or more clearing records of the plurality of clearing records of the clearing batch file based on a clearing record template associated with an issuer system,
wherein, when normalizing the one or more clearing records of the clearing batch file, the at least one processor converts one or more values associated with one or more key fields of the one or more clearing records to one or more updated values.

3. The computer-implemented method of claim 1, further comprising:
comparing, with at least one processor, a value associated with a second key field of the clearing record to a value associated with a second key field of the one or more authorization records, the second key field of the clearing record corresponding to the second key field of the one or more authorization records,
wherein determining that the clearing record corresponds to the authorization record from among the one or more authorization records comprises:
determining, with at least one processor, that the clearing record corresponds to the authorization record from among the one or more authorization records based on comparing the value associated with the second key field of the clearing record to the value associated with the second key field of the one or more authorization records;
wherein the first key field is associated with at least one of a transaction identifier, a transaction amount, and a payment account type, and
wherein the second key field is associated with another of the at least one of the transaction identifier, the transaction amount, and the payment account type.

4. The computer-implemented method of claim 3, wherein determining that the clearing record corresponds to the authorization record from among the one or more authorization records comprises:
determining, with at least one processor, that the value associated with the first key field of the clearing record matches the value associated with the first key field of the authorization record; and
determining, with at least one processor, that the value associated with the second key field of the clearing record does not match the value associated with the second key field of the authorization record,
the computer-implemented method further comprising:
determining, with at least one processor, that the clearing record partially matches the authorization record based on determining that the value associated with the first key field of the clearing record matches the value associated with the first key field of the authorization record and that the value associated with the second key field of the clearing record does not match the value associated with the second key field of the authorization record.

5. The computer-implemented method of claim 3, wherein determining that the clearing record corresponds to the authorization record from among the one or more authorization records comprises:
determining, with at least one processor, that the value associated with the first key field of the clearing record matches the value associated with the first key field of the authorization record; and
determining, with at least one processor, that the value associated with the second key field of the clearing record matches the value associated with the second key field of the authorization record,
the computer-implemented method further comprising:
determining, with at least one processor, that the clearing record matches the authorization record based on determining that the value associated with the first key field of the clearing record matches the value associated with the first key field of the authorization record and that the value associated with the second key field of the clearing record matches the value associated with the second key field of the authorization record.

6. The computer-implemented method of claim 3, wherein determining that the clearing record corresponds to the authorization record from among the one or more authorization records comprises:
determining, with at least one processor, that the value associated with the first key field of the clearing record does not match the value associated with the first key field of the authorization record; and
determining, with at least one processor, that the value associated with the second key field of the clearing record does not match the value associated with the second key field of the authorization record,
the computer-implemented method further comprising:
determining, with at least one processor, that the clearing record does not match the authorization record based on determining that the value associated with the first key field of the clearing record does not match the value associated with the first key field of the authorization record and that the value associated with the second key field of the clearing record does not match the value associated with the second key field of the authorization record.

7. The computer-implemented method of claim 1, wherein generating the updated clearing record comprises:
providing, with at least one processor, the clearing record and the authorization record as input to a machine learning model;
generating, with at least one processor, a prediction associated with a confidence score that the clearing record matches the authorization record based on providing the clearing record and the authorization record as the input to the machine learning model; and
updating, with at least one processor, the clearing record based on the confidence score.

8. The computer-implemented method of claim 7, wherein updating the clearing record based on the confidence score comprises at least one of:
appending, with at least one processor, the confidence score to the clearing record;
appending, with at least one processor, an original transaction amount of the authorization record to the clearing record; and
appending, with at least one processor, a transaction identifier of the authorization record to the clearing record.

9. The computer-implemented method of claim 2, further comprising:
generating, with at least one processor, an updated clearing batch file based on the clearing batch file and the updated clearing record;
wherein transmitting the updated clearing record comprises:
transmitting, with at least one processor, the updated clearing batch file to an issuer system.

10. The computer implemented method of claim 6, wherein generating the updated clearing record based on determining that the clearing record corresponds to the authorization record comprises:
providing, with at least one processor, the clearing record and the one or more authorization records to a machine learning model;
generating, with at least one processor, a prediction associated with a merchant transaction pattern and a confidence score based on providing the clearing record and the one or more authorization records to the machine learning model; and
updating, with at least one processor, the clearing record based on the merchant transaction pattern and the confidence score.

11. A system comprising a server including at least one processor, the at least one processor programmed and/or configured to:
receive a clearing record comprising at least one key field, the clearing record associated with one or more payment transactions that were completed in a payment transaction processing network;
compare a value associated with a first key field of the clearing record to a value associated with a first key field of one or more authorization records associated with one or more payment transactions that were authorized in the payment transaction processing network, the first key field of the clearing record corresponding to the first key field of the one or more authorization records, wherein the one or more authorization records are associated with an authorization request for a payment transaction of the one or more payment transactions;
determine that the clearing record corresponds to an authorization record from among the one or more authorization records based on comparing the value associated with the first key field of the clearing record to the value associated with the first key field of the one or more authorization records;
generate an updated clearing record based on determining that the clearing record corresponds to the authorization record; and
transmit the updated clearing record.

12. The system of claim 11, wherein receiving the clearing record associated with the one or more payment transactions comprises:
receiving a clearing batch file comprising a plurality of clearing records for a plurality of payment transactions,
the at least one processor being further programmed and/or configured to:
normalize one or more clearing records of the plurality of clearing records of the clearing batch file based on a clearing record template associated with an issuer system,
wherein, when normalizing the one or more clearing records of the clearing batch file, the at least one processor converts one or more values associated with one or more key fields of the one or more clearing records to one or more updated values.

13. The system of claim 11, wherein the at least one processor is further programmed and/or configured to:
compare a value associated with a second key field of the clearing record to a value associated with a second key field of the one or more authorization records, the second key field of the clearing record corresponding to the second key field of the one or more authorization records,
wherein determining that the clearing record corresponds to the authorization record from among the one or more authorization records comprises:
determining that the clearing record corresponds to the authorization record from among the one or more authorization records based on comparing the value associated with the second key field of the clearing record to the value associated with the second key field of the one or more authorization records;
wherein the first key field is associated with at least one of a transaction identifier, a transaction amount, and a payment account type, and
wherein the second key field is associated with another of the at least one of the transaction identifier, the transaction amount, and the payment account type.

14. The system of claim 13, wherein determining that the clearing record corresponds to the authorization record from among the one or more authorization records comprises:
determining that the value associated with the first key field of the clearing record matches the value associated with the first key field of the authorization record; and
determining that the value associated with the second key field of the clearing record does not match the value associated with the second key field of the authorization record,
the at least one processor being further programmed and/or configured to:
determine that the clearing record partially matches the authorization record based on determining that the value associated with the first key field of the clearing record matches the value associated with the first key field of the authorization record and that the value associated with the second key field of the clearing record does not match the value associated with the second key field of the authorization record.

15. The system of claim 11, wherein generating the updated clearing record comprises:
providing the clearing record and the authorization record as input to a machine learning model;
generating a prediction associated with a confidence score that the clearing record matches the authorization record based on providing the clearing record and the authorization record as the input to the machine learning model; and
updating the clearing record based on the confidence score.

16. A computer program product comprising a non-transitory computer-readable medium storing program instructions configured to cause at least one processor to:
receive a clearing record comprising at least one key field, the clearing record associated with one or more payment transactions that were completed in a payment transaction processing network;
compare a value associated with a first key field of the clearing record to a value associated with a first key field of one or more authorization records associated with one or more payment transactions that were authorized in the payment transaction processing network, the first key field of the clearing record corresponding to the first key field of the one or more authorization records, wherein the one or more authorization records are associated with an authorization request for a payment transaction of the one or more payment transactions;
determine that the clearing record corresponds to an authorization record from among the one or more authorization records based on comparing the value associated with the first key field of the clearing record to the value associated with the first key field of the one or more authorization records;
generate an updated clearing record based on determining that the clearing record corresponds to the authorization record; and
transmit the updated clearing record.

17. The computer program product of claim 16, wherein receiving the clearing record associated with the one or more payment transactions comprises:
receiving a clearing batch file comprising a plurality of clearing records for a plurality of payment transactions,
the program instructions being further configured to cause the at least one processor to:
normalize one or more clearing records of the plurality of clearing records of the clearing batch file based on a clearing record template associated with an issuer system,
wherein, when normalizing the one or more clearing records of the clearing batch file, the at least one processor converts one or more values associated with one or more key fields of the one or more clearing records to one or more updated values.

18. The computer program product of claim 16, wherein the program instructions are further configured to cause the at least one processor to:
compare a value associated with a second key field of the clearing record to a value associated with a second key field of the one or more authorization records, the second key field of the clearing record corresponding to the second key field of the one or more authorization records,
wherein determining that the clearing record corresponds to the authorization record from among the one or more authorization records comprises:
determining that the clearing record corresponds to the authorization record from among the one or more authorization records based on comparing the value associated with the second key field of the clearing record to the value associated with the second key field of the one or more authorization records;
wherein the first key field is associated with at least one of a transaction identifier, a transaction amount, and a payment account type, and
wherein the second key field is associated with another of the at least one of the transaction identifier, the transaction amount, and the payment account type.

19. The computer program product of claim 18, wherein determining that the clearing record corresponds to the authorization record from among the one or more authorization records comprises:
determining that the value associated with the first key field of the clearing record matches the value associated with the first key field of the authorization record; and
determining that the value associated with the second key field of the clearing record does not match the value associated with the second key field of the authorization record,
the program instructions being further configured to cause the at least one processor to:
determine that the clearing record partially matches the authorization record based on determining that the value associated with the first key field of the clearing record matches the value associated with the first key field of the authorization record and that the value associated with the second key field of the clearing record does not match the value associated with the second key field of the authorization record.

20. The computer program product of claim 16, wherein generating the updated clearing record comprises:
providing the clearing record and the authorization record as input to a machine learning model;
generating a prediction associated with a confidence score that the clearing record matches the authorization record based on providing the clearing record and the authorization record as the input to the machine learning model; and
updating the clearing record based on the confidence score.
